(19) United States
(12) Patent Application Publication
(10) Pub. No.: US 2008/0267552 A1
(43) Pub. Date: Oct. 30, 2008

(54) Shell-Type Needle Roller Bearing

(76) Inventor: Akira Takahashi, Kanagawa (JP)

Correspondence Address: KATTEN MUCHIN ROSENMAN LLP, 575 MADISON AVENUE, NEW YORK, NY, 10022-2585, US

(21) Appl. No.: 10/566,956

(22) PCT Filed: Jul. 29, 2004
(86) PCT No.: PCT/JP2004/010825

§ 371 Date: Mar. 21, 2008

(30) Foreign Application Priority Data
Jul. 30, 2003 (JP) 2003-282436

(51) Int. Cl. F16C 33/34; F16C 19/46

(52) U.S. Cl. 384/568

(57) ABSTRACT

Durability of a pair of inward flange portions 4b and 4c formed on both ends of a shell 1c is ensured while maintaining load capacity, irrespective of a thrust load applied from each needle 2a. Inside surfaces 10a and 10b of both inward flange portions 4b and 4c are formed as inclined surfaces inclined in a direction where a distance between the surfaces increases toward the radial inward direction. Each of both axial end surfaces of the needle 2a is constructed from a beveled portion 8 on an outer peripheral edge and a flat surface portion 9. The structure prevents a large moment load from being applied to base end portions of the inward flange portions 4b (4c) even when end surfaces of the needles 2a are abutted against an inside surface 10a (10b) of an inward flange portion 4b (4c) by a thrust load.

### TECHNICAL FIELD

The present invention relates to an improvement in a shell-type needle roller bearing used for example in parts which freely support oscillating displacement of a base end portion of a suspension arm for a rear wheel of a motorcycle, with respect to a frame thereof, in a state where a large radial load is supported, and moreover, the rotation angle is limited.

### BACKGROUND ART

A shell-type needle roller bearing is assembled in between the base end portion of a suspension arm for a rear wheel of a motorcycle, and the frame thereof, and freely supports oscillating displacement of the suspension arm with respect to the frame.

As a shell-type needle roller bearing which can be assembled in such parts, those which are disclosed for example in Patent Documents 1 to 8, and Non-patent Document 1, are conventionally known. Among these, each of the shell-type needle roller bearings disclosed in Patent Documents 1 to 8 retain a plurality of needles by way of a cage so as to roll (rotate) freely. Although relatively high-speed rotation can be managed by such a shell-type needle roller bearing with a built-in cage due to the movement of the needles being smoothly performed, the number of needles which can be built-in becomes fewer, and the load capacity becomes smaller.

However, in a shell-type needle roller bearing which is assembled in parts which freely support oscillating displacement of the suspension arm with respect to the frame, although high-speed rotation is not required, a large load capacity is required. Therefore, as a shell-type needle roller bearing assembled in such parts, a full complement needle roller bearing is utilized, with only needles on the radial inside of the shell and the cage omitted. As a shell-type full complement needle roller bearing, FIG. 4 shows one which is disclosed in Non-patent Document 1.

This shell-type full complement needle roller bearing is made with a plurality of needles 2 on the radial inside of a cylindrical shell 1, which are not retained by a cage, in other words, are arranged in a state where the rolling surfaces of circumferentially adjacent needles 2 are directly adjacent and facing, or are in contact with each other. The shell 1 is formed by plastic working such as drawing work, and the like, on a metallic plate of a hard metal such as case hardened steel, bearing steel, carbonitrided steel, and the like, and is provided with a cylinder portion 3, and a pair of inward flange portions 4 which are formed by bending both axial end portions of the cylinder portion 3 radially inwards. In the case of the conventional example shown in FIG. 4, the inner peripheral edge portions of these inward flange portions 4 are bent axially inwards, so that engaging concave portions 5 are formed on the inside surfaces of both these inward flange portions 4, in a state continuous around the perimeter. Moreover, engaging protrusions 6 which project from the center of both axial end surfaces of the needles 2 are introduced to inside the engaging concave portions 5, to thereby prevent separation of the needles 2 from the shell 1.

In order to freely support oscillating displacement of the base end portion of a suspension arm for a rear wheel of a motorcycle, with respect to the frame, by such a shell-type needle roller bearing, the shell 1 is securely fitted into a housing portion provided on the frame side. Furthermore, a swing pivot shaft, which is secured to the base end portion of the suspension arm, is inserted into the radial inside of the needles 2. As a result, the suspension arm is supported with respect to the housing portion, so as to freely oscillate about this swing pivot shaft. When the rear wheel goes up and down with respect to the frame at the time of travelling, the swing pivot shaft undergoes oscillating displacement while the needles 2 are rolled in both directions. At this time, the swing angle is a small value from 1 to less than a few degrees.

When a shell-type full complement needle roller bearing as shown in FIG. 4 is utilized in a part which undergoes oscillating displacement through a small angle while supporting a thrust loading, with usage over a long period of time there is a possibility of the shell 1 becoming damaged, and the rolling of the needles 2 becoming no longer smoothly performed. That is to say, when the shell-type needle roller bearing undergoes a back and forth oscillating displacement through a small angle while under a thrust load, any tip end surfaces of the engaging protrusions 6 projecting from the axial end surfaces of the needles 2 move back and forth at the contact portion in a state abutted with a portion on the inside surface of the inward flange portion 4 facing the engaging protrusions 6, thus wearing the contact portion. Then, when the wearing progresses, as shown in FIG. 5, an engaging protrusion 6 breaks through the inward flange portion 4, and the revolving movement of the needle 2 provided with this engaging protrusion 6 becomes impossible. Regarding the needles 2 constituting the shell-type needle roller bearing, since the rolling surfaces of the circumferentially adjacent needles 2 are in contact or are adjacent and facing each other, if the revolving movement of any one of the needles 2 becomes obstructed, the revolving movement of all of the needles 2 is no longer smoothly performed. Hence the resistance with respect to the oscillating displacement of the member inserted on the radial inside of the needles 2, such as the swing pivot shaft, becomes larger.

To prevent the occurrence of such a deficiency, as shown in FIG. 6, it is considered to form the inward flange portions 4a on the axial end portions of the shell 1a in a simple flat state, and to make the contact area between the inside surfaces of these inward flange portions 4a and the axial end surfaces of the needles 2a broader. Such a construction as shown in FIG. 6, is representative of a full complement needle roller bearing, with the retainer removed from the construction shown in Patent Documents 2 to 8.

However, in the case of the construction shown in FIG. 6, it is difficult to form the inside surfaces of the inward flange portions 4a, completely orthogonal to the central axis of the shell 1a, and to make these inside surfaces of the inward flange portions 4a completely parallel to the axial end surfaces of the needles 2a. Furthermore, due to unavoidable manufacturing error, as shown with exaggeration in FIG. 7, there is a possibility for any part of the inward flange portions 4a to become deformed, so that the tip end portion (radial inner edge portion) of this inward flange portion 4a and the axial end surfaces of the needles 2a come into contact. If a thrust load is applied to the inward flange portion 4a from the needles 2a in such a state, a large moment is applied to the inward flange portion 4a. As a result, it becomes easy for damage such as cracking, to occur at the base end portion of the inward flange portions 4a (the continuous portion between the inward flange portion 4a and the cylinder portion 3). Then in the case where damage has occurred and the inward flange portion 4a has fallen out, the needles 2a come out from the radial inside of the shell 1a, and the function of the shell-type needle roller bearing is lost.

To resolve either of the deficiencies mentioned above, as shown in FIG. 8, it has also been considered to form a pair of folded portions 7 on both axial end portions of a shell 1b, by folding the metallic plate which constitutes the shell 1b back through 180 degrees, and use the two folded portions 7 to effect axial positioning of the plurality of needles 2 arranged on the radial inside of the shell 1b. Such a construction as shown in FIG. 8, is representative of a full complement needle roller bearing, with the retainer removed from the construction shown in Patent Document 1. However, in the case of such a construction shown in FIG. 8, the axial dimensions of the folded portions 7 are increased. As a result, in the case where the axial length of the shell 1b is made the same, the axial length of the needles 2a must be made shorter, and the load capacity of the shell-type needle roller bearing becomes correspondingly smaller.

### [Patent Document 1]

Japanese Patent Application Publication No. Hei 6-264930.

### [Patent Document 2]

Japanese Patent Application Publication No. Hei 7-71450.

### [Patent Document 3]

Japanese Patent Application Publication No. Hei 8-326744.

### [Patent Document 4]

Japanese Patent Application Publication No. Hei 11-190352.

### [Patent Document 5]

Japanese Patent Application Publication No. 2000-291669.

### [Patent Document 6]

Japanese Patent Application Publication No. 2001-65575.

### [Patent Document 7]

Japanese Patent Application Publication No. 2001-173666.

### [Patent Document 8]

Published Japanese Translation No. 2003-502603 of PCT International Publication.

### [Non-patent Document 1]

Catalog “Rolling Bearing”, NSK Ltd., 1995, B242, B254.

### DISCLOSURE OF INVENTION

### Problems to be Solved by the Invention

The present invention takes the above circumstances into consideration, and has been invented to realize a shell-type needle roller bearing that can maintain load capacity, and prevent the occurrence of damage, such as extensive wear and cracking, to this inward flange portion, irrespective of the thrust load applied to the inward flange portion through the needles.

### Means for Solving the Problem

The shell-type needle roller bearing of the present invention, as with the aforementioned conventionally known shell-type needle roller bearings, comprises a shell, and a plurality of needles.

Of these, the shell has both axial end portions of a cylinder portion bent radially inwards to form a pair of inward flange portions.

Furthermore, the needles are provided so as to roll freely on a radial inside portion of the cylinder portion between inside surfaces of both inward flange portions, without being retained by a cage, in a state where they are directly adjacent and facing or in contact with the rolling surfaces of circumferentially adjacent needles.

In particular, in the shell-type needle roller bearing of the present invention, the inside surfaces of both inward flange portions make up inclined surfaces which are inclined in a direction where a distance between the surfaces becomes narrower towards the radial outward direction.

Furthermore, of both axial end surfaces of the needles, a portion nearer the center than a beveled portion on an outer peripheral portion, is shaped such that it does not project axially outwards more than an inner peripheral edge of the beveled portion.

Furthermore, in a state where the needles are displaced in the axial direction, contact portions between both axial end surfaces of the needles and the inside surfaces of the inward flange portions are positioned at portions close to the radial outside of the inward flange portions.

### EFFECTS OF THE INVENTION

In the case of the shell-type needle roller bearing of the present invention constructed as described above, by ensuring a sufficient space between the inside surfaces of the pair of inward flange portions, the axial length of the needles installed between both inward flange portions is ensured, and the load capacity can be ensured.

Furthermore, the occurrence of considerable wear, which becomes a cause for disruption of the rolling and revolving movement of these needles, at the contact portion between the inside surfaces of both inward flange portions and both axial end surfaces of the needles, can be prevented.

Moreover, in the case where a thrust load is applied from the needle roller bearings to the inside surface of either of the inward flange portions, the point of application of this thrust load is at a portion near the radial outside of the inward flange portion, that is to say, is applied at a portion in the vicinity of the continuous portion between the inward flange portion and the cylinder portion. As a result, the distance (span) between the point of application of the thrust load and the continuous portion, which similarly becomes a point of action, is made shorter, so that the moment load (bending stress and tensile stress) applied to the continuous portion is kept down, and the occurrence of damage to the continuous portion, such as cracking, can be prevented.

### BRIEF DESCRIPTION OF THE DRAWINGS

FIG. 1 is a partial cross section showing an example 1 of the present invention.

FIG. 2 is an enlarged cross section showing a shell by itself.

FIG. 3 is an enlarged cross section of a loft end portion of FIG. 2.

FIG. 4 is a cross section showing an example of a conventional construction.

FIG. 5 is a partial cross section corresponding to a right end portion of FIG. 4, for explaining a deficiency which occurs in the conventional construction.

FIG. 6 is a partial cross section showing a first example of a previously considered construction for solving the deficiency.

FIG. 7 is a partial cross section corresponding to a right end portion of FIG. 6, for explaining a deficiency which occurs in the case of the first example.

FIG. 8 is a partial cross section showing a second example of a previously considered construction for solving the aforementioned deficiency.

### BEST MODE FOR CARRYING OUT THE INVENTION

In the case where the shell-type needle roller bearing of the present invention is implemented, the angle of the inside surfaces of both inward flange portions with respect to a virtual plane which exists in a direction orthogonal to a central axis of the shell, is preferably made to be 3 to 20 degrees, and at both axial end surfaces of the needles, a portion nearer the center than the beveled portion is made a flat surface.

By having such a configuration, the contact portion between both axial end surfaces of the needles and the inside surfaces of both inward flange portions can be stably positioned at a portion nearer the radial outside of both inward flange portions. In a case where the angle is less than 3 degrees, then due to manufacturing error, there is a possibility of the inside surface of one of the inward flange portions being inclined in the opposite direction. In that case the contact portion becomes present at a radial inward portion of the inside surface, so that the moment load applied to the continuous portion between the inward flange portions and the cylinder portion becomes large on the other hand, if the angle exceeds 20 degrees, it becomes difficult to suppress the axial dimensions of the shell, while maintaining the strength and the rigidity of both inward flange portions.

Furthermore, in relation to the radial direction of the shell, a distance between an inner peripheral edge of both inward flange portions and an inner peripheral surface of the cylinder portion, is made smaller than a diameter of the cross section of the needles, and larger than ⅓ of this diameter. Making this distance smaller than the diameter of the cross section of the needles, is necessary to make the rolling surfaces of the needles project radially inward more than the inner peripheral edge of both inward flange portions, so that the rolling surfaces of the needles, and the peripheral surface of the axial member which has been inserted to the inside of these needles, such as the swing pivot shaft, are contacted with each other. On the other hand, it is necessary to make the distance larger than ⅓ of the diameter so as to form both inward flange portions with stability. If the distance is less than or equal to ⅓ of the diameter, the formation process of both inward flange portions becomes difficult, making it hard to restrict the incline angle of the inside surfaces of both inward flange portions to the desired range (3 to 20 degrees). If fabrication of both inward flange portions is to be performed with the incline angle kept stable, the shorter distance is preferable.

More preferably the needles are affixed to an inner peripheral surface of the shell using grease. If constructed in this manner, then even before the shell-type needle roller bearing is assembled in the oscillating support portion, the needles will not inadvertently fall out from the inner peripheral surface of the shell, and simplification of the assembly process can be achieved.

### EXAMPLES

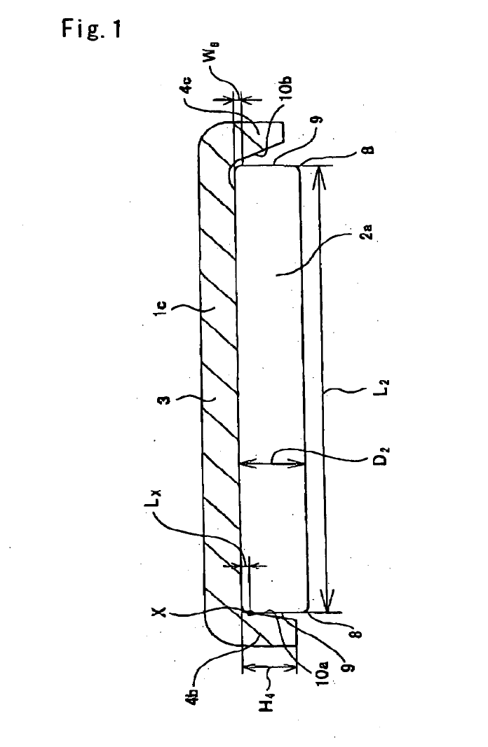

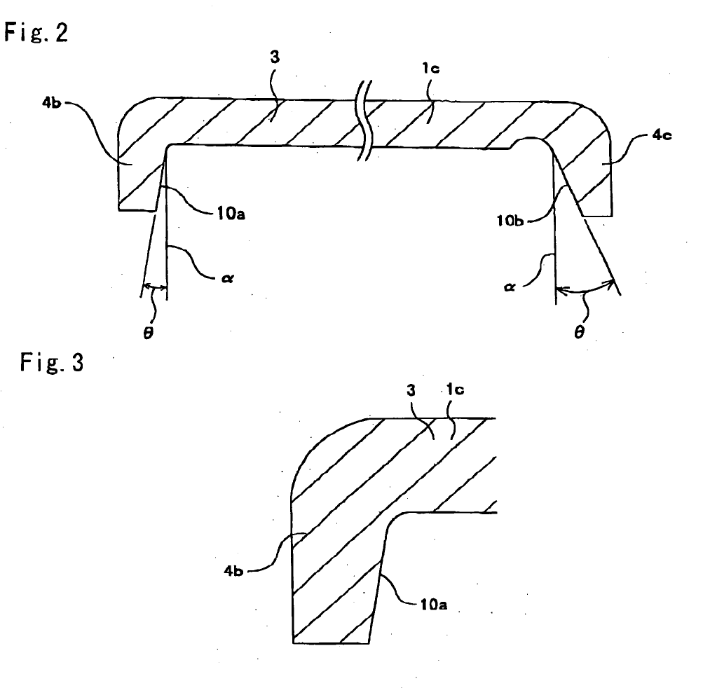

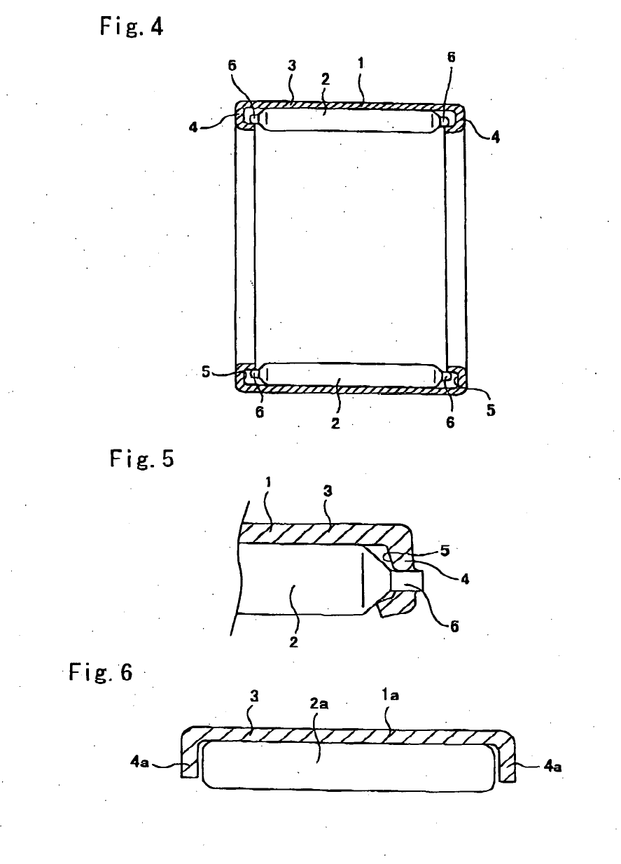

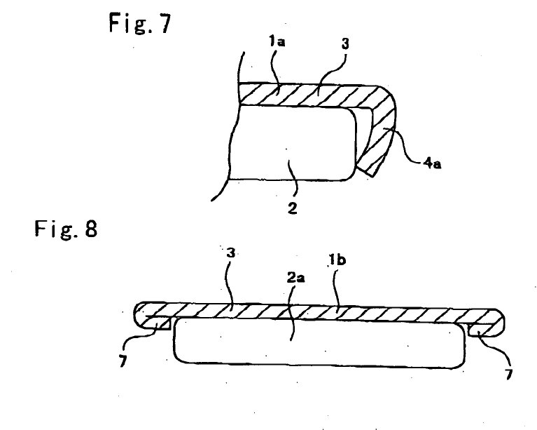

FIG. 1 to 3 show examples of the present invention. The shell-type needle roller bearing comprises a shell 1c, and a plurality of needles 2a. The shell 1c is made by bending both axial end portions of the cylinder portion 3 radially inwards to form a pair of inward flange portions 4b and 4c. Furthermore, the needles 2a are provided so as to roll freely in the radial inside portion of the cylinder portion 3 between the inside surfaces of both inward flange portions 4b and 4c, without being held by a cage, and in a state where the rolling surfaces of circumferentially adjacent needles 2a are directly adjacent and facing, or in contact with each other.

Both axial end surfaces of the needles 2a comprise a beveled portion 8 which constitutes an outer peripheral edge portion, and a flat portion 9 of a portion nearer the center than the beveled portion 8. Although it is not possible to form a convex portion on the central portion of this flat portion 9, a concave portion can be freely formed. Furthermore, inside surfaces 10a and 10b of both inward flange portions 4b and 4c are inclined surfaces which are inclined in a direction where the distance between the surfaces becomes narrower towards the radial outward direction. An angle θ of both inside surfaces 10a and 10b, with respect to a virtual plane α which exists in a direction orthogonal to the central axis of the shell 1c, is made to be 3 to 20 degrees. In the case of the present example, the plate thickness of both inward flange portions 4b and 4c is made to become smaller towards the rim (the inner peripheral edge), and the angle θ is given to the inside surfaces 10a and 10b of both inward flange portions 4b and 4c. The outside surfaces of both inward flange portions 4b and 4c are approximately parallel to the virtual plane α.

Accordingly, the thickness of both inward flange portions 4b and 4c is less than or equal to the thickness of the metallic plate which constitutes the shell 1c. Therefore, it is possible to suppress the proportion of the axial length of the shell 1c occupied by both inward flange portions 4b and 4c, while sufficiently maintaining the space between the inside surfaces 10a and 10b of both inward flange portions 4b and 4c. Moreover, an axial length L₂ of the needles 2a installed between the inside surfaces 10a and 10b of both inward flange portions 4b and 4c is secured, and hence the load capacity of the shell-type needle roller bearing can be maintained. In particular, since the angle θ is restricted to less than or equal to 20 degrees, the thickness dimensions of both inward flange portions 4b and 4c can be secured, and hence the load capacity can be maintained while ensuring the strength and rigidity of both inward flange portions 4b and 4c.

Furthermore, the contact state of the inside surfaces 10a and 10b of both inward flange portions 4a and 4b, and the axial end surfaces of the needles 2a, is not a state where the surface pressure becomes high in parts. Therefore the occurrence of considerable friction at the contact portions of the inside surfaces 10a and 10b with the axial end surfaces of the needles 2a, which can become a cause of obstruction to the rolling and revolving movement of the needles 2a, can be prevented. That is to say, the contact portion of both the surfaces becomes a contact state of curved surfaces with a comparatively large radius of curvature. Therefore as well as being able to suppress the surface pressure at the contact portion, it becomes easier to form an excellent oil film at the contact portion. As a result, the occurrence of considerable friction as mentioned above, can be prevented.

Moreover by making the shape of both axial end surfaces of the needles 2a, and the shape of the inside surfaces 10a and 10b of both inward flange surfaces 4b and 4c in the above manner, the contact portion between both axial end surfaces of the needles 2a, and the inside surfaces 10a and 10b of the inward flange portions 4b and 4c, in a state where the needles 2a have moved in the axial direction, is positioned at a portion close to the radial outside (close to the top in FIG. 1 to 3) of the inward flange portions 4b and 4c. That is to say, in a working state, the swing pivot shaft (not shown in the figures) passes through the radial inside of the needles 2a, and when a thrust load based on the frictional force acting between the outer peripheral surface of the swing pivot shaft, and the rolling surfaces of the needles 2a, is applied from the swing pivot shaft to the needles 2a, the faces on one end of the two axial end surfaces of the needles 2a are abutted at a contact point X, against the inside surface 10a of the inward flange portion 4b (or the inside surface 10b of the inward flange portion 4c).

At this time, the axial end surfaces of the needles 2a abut against the inside surface 10a (or 10b) at the continuous portion between the beveled portion 8 and the flat surface portion 9, or at a portion in the vicinity of this continuous portion. Because a width W₈ in relation to the radial direction of the beveled portion 8 is narrow, a distance Lₓ (˜W₈) in relation to the radial direction between the rolling surface of the needles 2a and the contact point X is short. Therefore, the point of application of the thrust load applied from the needles 2a to the inside surfaces 10a (or 10b) is at a portion near the radial outside of the inside surface 10a (or 10b), that is to say, it is applied to a portion in the vicinity of the continuous portion between the inside surface 10a (or 10b) and the inner peripheral surface of the cylinder portion 3. As a result, the distance (span) between the point of application of the thrust load and the continuous portion, which similarly becomes a point of action, is made shorter, so that the moment load (bending stress) applied to the continuous portion is kept down, and the occurrence of damage to the continuous portion, such as cracking, can be prevented.

Because the angle θ of both inside surfaces 10a and 10b, with respect to a virtual plane α which exists in a direction orthogonal to the central axis of the shell 1c, is greater than or equal to 3 degrees, then even in a case where the angle θ slightly deviates from the design value as a result of manufacturing error, the inside surface 10a of the inward flange portion 4b (or the inside surface 10b of the inward flange portion 4c) does not become inclined in the opposite direction. Therefore, it is possible to effectively prevent the occurrence of damage to the continuous portion, such as cracking, without making the processing accuracy particularly strict.

Furthermore, in relation to the radial direction of the shell 1c, a distance H₄ between the inner peripheral edge of both inward flange portions 4b and 4c, and the inner peripheral surface of the cylinder portion 3 (the cross-sectional height of the inward flange portions 4b and 4c) is made smaller than a diameter D₂ of the cross section of the needles 2a, and larger than ⅓ of this diameter D₂ (D₂>H₄>D₂/3). By restricting the distance H₄ to within this range, the rolling surfaces of the needles 2a are projected radially inward more than the inner peripheral edge of both inward flange portions, so that the rolling surfaces of the needles 2a and the outer peripheral surface of the swing pivot shaft are contacted with each other, and the swing pivot shaft can be supported so as to oscillate freely. On the other hand, by making the distance H₄ larger than ⅓ of the diameter D₂, the formation process for both inward flange portions 4b and 4c is made easier, and the incline angle θ of the inside surfaces 10a and 10b of both these inward flange portions 4b and 4c becomes easier to control to the desired range (3 to 20 degrees).

Furthermore, the needles 2a are affixed to the inner peripheral face of the cylinder portion 3 of the shell 1c using grease. Therefore, even before the shell-type needle roller bearing is assembled in the oscillating support portion, the needles 2a will not inadvertently fall out from the inner peripheral surface of the shell 1c, and simplification of the assembly process can be achieved.

### INDUSTRIAL APPLICABILITY

The shell-type needle roller bearing of the present invention is not limited to parts which freely support oscillating displacement of the base end portion of a suspension arm for a rear wheel of a motorcycle, with respect to the frame thereof, and can be utilized in parts which oscillate and are displaced through a small angle under a thrust load, for example, the oscillating support portion of the base end portion of various types of robot arms, and the like.

1. A shell-type needle roller bearing comprising: a shell with both axial end portions of a cylinder portion bent radially inwards to forms a pair of inward flange portions; and a plurality of needles which are provided so as to roll freely on a radial inside portion of the cylinder portion between inside surfaces of both inward flange portions, without being retained by a cage, in a state where they are directly adjacent and facing or in contact with the rolling surfaces of circumferentially adjacent needles, wherein
the inside surfaces of both inward flange portions make up inclined surfaces which are inclined in a direction where a distance between the surfaces becomes narrower towards the radial outward direction,
of both axial end surfaces of the needles, a portion nearer the center than a beveled portion on an outer peripheral portion, is shaped such that it does not project axially outwards more than an inner peripheral edge of the beveled portion, and
in a state where the needles are displaced in the axial direction, contact portions between both axial end surfaces of the needles and the inside surfaces of the inward flange portions are positioned at portions close to the radial outside of the inward flange portions.

2. A shell-type needle roller bearing according to claim 1, wherein an angle of the inside surfaces of both inward flange portions with respect to a virtual plane which exists in a direction orthogonal to a central axis of the shell, is 3 to 20 degrees, and at both axial end surfaces of the needles, a portion nearer the center than the beveled portion is a flat surface.

3. A shell-type needle roller bearing according to claim 1, wherein in relation to the radial direction of the shell, a distance between an inner peripheral edge of both inward flange portions and an inner peripheral surface of the cylinder portion, is made smaller than a diameter of the cross section of the needles, and larger than ⅓ of the diameter.

4. A shell-type needle roller bearing according to claim 1, wherein the needles are affixed to an inner peripheral surface of the shell using grease.
